(19) United States
(12) Patent Application Publication
(10) Pub. No.: US 2010/0096770 A1
(43) Pub. Date: Apr. 22, 2010

(54) Method for fabrication of mold for nano imprinting and method for production of photonic crystal using the same

(75) Inventors: Young Tae Cho, Suwon-si (KR); Jeong Gil Kim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/585,874

(22) Filed: Sep. 28, 2009

(30) Foreign Application Priority Data
Oct. 20, 2008 (KR) 10-2008-0102615

(51) Int. Cl. B29C 33/42

(52) U.S. Cl. 264/225

(57) ABSTRACT

A manufacturing process using a replica mold for nano imprinting having a grid type pattern by combining a nano imprint with a dry etching process is disclosed. In order to attain such a manufacturing process, a method of fabricating a mold for nano imprinting may include arranging a master mold having first patterns over a substrate having metal patterns so that both the first pattern and the metal pattern cross over each other, applying resin between the master mold and the substrate, applying an imprinting treatment of the substrate as well as the master mold, hardening the resin, and etching the hardened resin after the master mold is released, so as to form a replica mold for nano imprint. The nano imprinting process and the etching process may easily form a pattern in a more complicated structure, and therefore, may improve production yield and reduce processing time thereof.

### CROSS-REFERENCE TO RELATED APPLICATION

This application claims priority under 35 U.S.C. §119 to Korean Patent Application No. 2008-0102615, filed on Oct. 20, 2008 in the Korean Intellectual Property Office (KIPO), the entire contents of which are herein incorporated by reference.

### BACKGROUND

1. Field

Example embodiments relate to a method of manufacturing a mold for nano imprinting and a method of manufacturing photonic crystals using the same. More particularly, example embodiments relate to a method of fabricating a mold for nano imprinting, which may have a grid structure, using a dry etching process. Example embodiments as also relate to a method of nano imprinting. In addition, example embodiments relate to a method for producing photonic crystals using the fabricated mold for nano imprinting by a nano imprinting process.

2. Description of the Related Art

A conventional nano imprinting process uses a mold to form a nanoscale pattern. The nanoscale pattern has an imprint form and a size in the range of 1 to 100 nm. The conventional nano imprinting process uses a master mold to directly form the pattern on a substrate. The master mold may also be used to fabricate a replica mold and the fabricated replica mold may be used to form a pattern.

Such nano imprinting processes may adopt a relatively simple process compared to existing photo-lithography processes in order to form a pattern and, if using a three-dimensional pattern mold, a three-dimensional pattern may be formed relatively easy. Also, when a mold having narrow line width of less than 30 nm is used, fine line width patterns, usually unable to be embodied by photo-lithography, may be formed. Therefore, the nano imprinting process exhibits beneficial features, for example, relatively high productivity and relatively low cost. Accordingly, the nano imprinting process is used in a relatively wide range of applications including semiconductor processes and flat panel display manufactures.

As to application of the nano imprinting process to form a pattern, a mold with a desired shape must first be prepared. For example, in order to prepare a mold with a narrow line width, E-beam lithography or focused ion beam lithography has recently been employed. However, E-beam lithography or focused ion beam lithography with a nanometer (nm) scale resolution has difficulty in forming patterns having a size of not more than about 50 nm.

In addition, as to formation of a nano grade pattern, which has a repetitive three-dimensional pattern in a dot structure, an exposure process must be repeated or other relatively high cost processes, for example, laser processing, must be used.

### SUMMARY

Example embodiments provide a method for fabricating a mold for nano imprinting (often referred to as “nano imprint mold”) with a grid type pattern, which may include a dry etching process combined with nano imprinting.

Example embodiments also provide a method for producing photo crystals with a repetitive pattern in a dot structure, which may include using the mold for nano imprinting fabricated as described above.

In accordance with example embodiments, a method of fabricating a mold for nano imprinting may include providing a master mold having a first pattern, providing a substrate having a second pattern, arranging the master mold on the substrate so that the first pattern and the second pattern cross over each other, applying resin between the master mold and the substrate, imprinting the resin by pressing the master mold against the substrate, hardening the resin, releasing the master mold from the resin, and etching the hardened resin to form a replica mold for nano imprinting.

In accordance with example embodiments, a method of fabricating a mold for nano imprinting may include preparing a master mold patterned with first linear patterns in parallel, preparing a substrate patterned with linear metal patterns in parallel, arranging the master mold and the substrate such that both the first linear patterns and the linear metal patterns cross over each other, applying resin between the master mold and the substrate, imprinting the substrate and the master mold and hardening the resin, and etching the hardened resin after the master mold is released, so as to form a replica mold for nano imprinting patterned with a third pattern in a grid form.

In accordance with example embodiments, a method of producing photo crystals may include applying a mold resin between a master mold and a first substrate and imprinting the mold resin, hardening the mold resin, forming a replica mold by etching the hardened mold resin to form a grid type pattern on the first substrate, coating an imprint resin on a second substrate, pressing the replica mold against the coated second substrate to imprint the grid type pattern of the replica mold on the imprint resin, and releasing the replica mold from the imprint resin.

In accordance with example embodiments, a method of fabricating a nano imprint mold may include arranging a master mold patterned with first parallel patterns and a substrate patterned with parallel metal patterns such that both the first pattern and the metal pattern cross over each other, applying specific resin between the master mold and the substrate, imprinting the substrate as well as the master mold and hardening the resin, and etching the hardened resin after the master mold is released, so as to form a replica mold for nano imprinting.

The crossover arrangement of the first pattern and the metal pattern may be conducted such that the first pattern is perpendicularly aligned to the metal pattern.

Depending on a cross angle between the first pattern and the metal pattern, a shape of the pattern may be varied.

The process of fabricating the replica mold for nano imprinting may include a dry etching process with use of a resin etching gas until a residual film is removed.

The process of fabricating the replica mold for nano imprinting may etch the resin to form a second pattern in a grid form.

The method of fabricating of the nano imprint mold may further include a process for surface treatment of the replica mold by applying an anti-adhesion layer thereto, after completion of the etching process.

The resin application process between the master mold and the substrate may further include application of an adhesive promoter in order to reinforce adhesiveness between the substrate patterned with the metal pattern and the resin.

In accordance with example embodiments, an alternative method for fabricating of a nano imprint mold may include preparing a master mold patterned with first linear patterns in parallel, preparing a substrate patterned with linear metal patterns in parallel, arranging the master mold and the substrate such that both the first pattern and the metal pattern cross over each other, applying specific resin between the master mold and the substrate, imprinting the substrate as well as the master mold and hardening the resin, and etching the hardened resin after the master mold is released, so as to form a replica mold for nano imprinting patterned with a second pattern in a grid form.

The method for producing photo crystals according to example embodiments may include applying a mold resin between the master mold and a first substrate and imprinting the same, etching the hardened resin to fabricate a replica mold for nano imprinting, on which a grid type pattern is formed, applying an imprint resin to a second substrate, pressing the replica mold for nano imprinting to the coated second substrate so as to imprint the pattern of the replica mold, and releasing the replica mold for nano imprinting from the second substrate.

The process for application of the mold resin between the master mold and the first substrate, then, for imprinting treatment of the same may further include arrangement of the master mold patterned with first parallel patterns and the substrate patterned with parallel metal patterns such that both the first pattern and the metal pattern cross over each other.

The process of fabricating the replica mold may further include surface treatment of the replica mold by applying an anti-adhesion layer thereto.

The imprint resin may be a nano imprint material which is UV curable resin.

The second substrate may have protrusions in a rectangular form, which are spaced apart from one another and have uniform size.

As described above, the method of fabricating a nano imprint mold according to example embodiments may include simultaneously imprinting and an etching process to fabricate a nano imprint mold, which has a grid type pattern. Consequently, because a repetitive pattern in a complex dot structure may be obtained by a single formation process, a high cost exposure process may be omitted and the formed patterns may be used as photo crystals.

Moreover, the nano imprint mold fabricated as described above may be used in manufacturing photo crystals, thereby contributing to reduction of processing cost, reduction of processing time and/or increased production yield.

Additional aspects of example embodiments will be set forth in part in the description which follows and, in part, will be obvious from the description, or may be learned by practice of the invention.

### BRIEF DESCRIPTION OF THE DRAWINGS

Example embodiments will be more clearly understood from the following detailed description taken in conjunction with the accompanying drawings. FIGS. 1A-5 represent non-limiting, example embodiments as described herein.

FIGS. 1A to 1E are process flow diagrams illustrating a method of fabricating a replica mold for nano imprinting by a dry etching process as well as nano imprinting, according to example embodiments;

FIGS. 2A to 2D are process flow diagrams illustrating a method for producing photo crystals using the replica mold for nano imprinting fabricated according to example embodiments;

FIGS. 3A to 3E are process flow diagrams illustrating a method of fabricating a replica mold for nano imprinting by a dry etching process as well as nano imprinting, according to example embodiments;

FIGS. 4A to 4D are process flow diagrams illustrating a method of producing photo crystals using the replica mold for nano imprinting fabricated according to the example embodiments; and

FIG. 5 is an operation block diagram illustrating a method of producing photo crystals, on which a repetitive pattern in a dot structure is formed, by the nano imprinting process according to example embodiments.

### DETAILED DESCRIPTION

Example embodiments will now be described more fully with reference to the accompanying drawings, in which example embodiments are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments.

Reference will now be made in detail to example embodiments which are illustrated in the accompanying drawings, wherein like reference numerals refer to the like elements throughout.

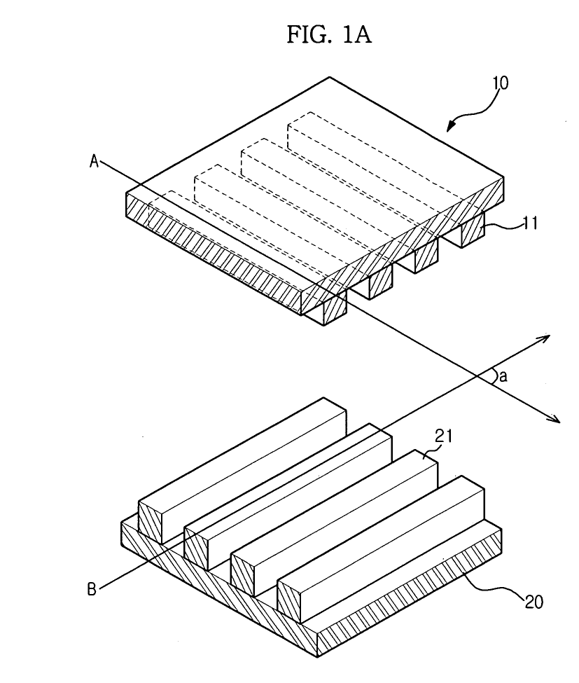

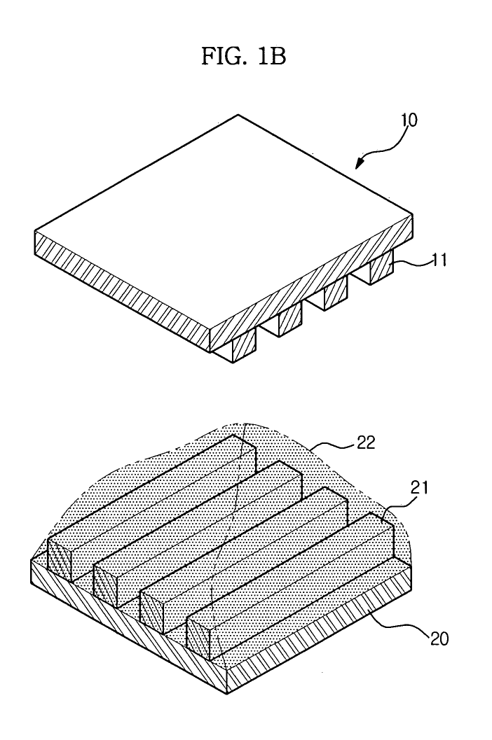

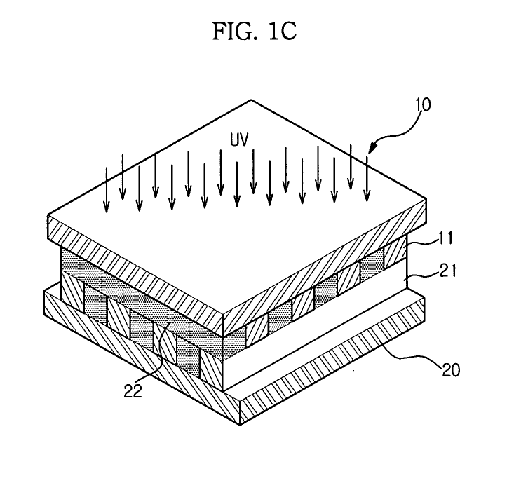

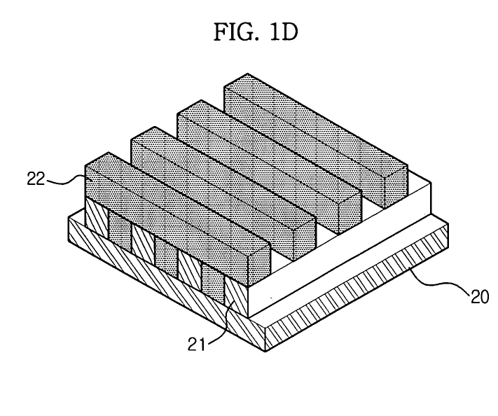

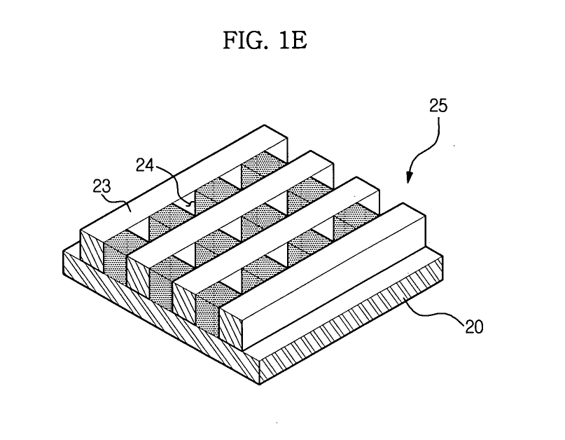

FIGS. 1A to 1E are process flow diagrams illustrating a method of fabricating a replica mold for nano imprinting by a dry etching process as well as nano imprinting, according to example embodiments.

As shown in FIG. 1A, a master mold 10 and a first substrate 20 are prepared. The master mold 10 may include a first pattern 11 formed thereon and the first substrate 20 may include a second pattern 21 formed thereon. The first and second patterns 11 and 21 may be made via a conventional patterning process, for example, by photo lithography, nano imprint lithography, and E-beam lithography.

As shown in FIG. 1A, the first and second patterns 11 and 21 may be linear patterns aligned in parallel at equal intervals. However, example embodiments are not limited thereto. For example, the first and second patterns 11 and 21 may have a different orientation or may be arranged as linear patterns aligned in parallel at irregular intervals. As another example, the first and second patterns 11 and 21 may include streamline type patterns that are aligned in parallel.

The first pattern 11 of the master mold 10 may be different from the second pattern 21 of the first substrate 20. The second pattern 21 of the first substrate 20, for example, may be a metal pattern.

The master mold 10 and the first substrate 20 patterned with patterns 11 and 21 may be arranged so that the first pattern 11 of the master mold 10 and the second pattern 21 of the first substrate 20 cross over each other. In this regard, depending on a cross angle “a” between the first pattern 11 formed in direction A of the master mold 10 and the second pattern 21 formed in direction B of the first substrate 20, a shape of a third pattern 23 (see FIG. 1E) may be established or determined. In example embodiments, the cross angle “a” between the first pattern 11 of the master mold 10 and the second pattern 21 of the first substrate 20 may be set to a right angle as shown in FIG. 1A, however, example embodiments are not limited thereto. For example, the cross angle “a” may be set to an angle other than a right angle.

Referring to FIG. 1B, a UV curable mold resin 22 may be applied between the master mold 10 and the first substrate 20. In example embodiments the master mold 10 and the first substrate 20 may be arranged first and then the mold resin 22 may be applied between the master mold 10 and the first substrate 20. However, example embodiments are not limited thereto. For example, the mold resin 22 may be applied to the first substrate 20 and then the master mold 10 and the first substrate 20 are aligned as disclosed above.

Referring to FIG. 1C, the master mold 10 may be combined with the first substrate 20 and the master mold 10 may be pressed which in turn presses the mold resin 22 applied between the master mold 10 and the first substrate 20. Accordingly, the mold resin 22 may undergo imprinting of a pattern. The mold resin may be hardened by applying UV (ultraviolet) radiation at the master mold side 10.

Referring to FIG. 1D, the master mold 10 may be released from the mold resin 22 and unhardened portions of the mold resin 22 may be washed with a solvent, for example, alcohol, to provide the first substrate 20 patterned with the mold resin 22, which was already patterned with the second pattern 21. In order to increase adhesiveness between the second pattern 21 and the mold resin 22, an adhesion promoter may be applied.

Referring to FIG. 1E, a specific gas capable of etching only the mold resin 22 may be used to execute a dry etching process, for example, reactive ion etching (RIE). In example embodiments, the dry etching process may be continued until a residual film is completely removed, resulting in a replica mold for nano imprinting 25 with a third pattern 23 as a three-dimensional pattern.

The third pattern 23 may be formed in a grid form and rectangular holes 24 may be represented in the grid.

The replica mold for nano imprinting 25 with the grid type three-dimensional pattern, that is, the third pattern 23 formed by the above process, may be used to manufacture photo crystals.

A photo crystal is an optical structure with relatively strong dispersive properties as well as a photonic band gap, localized light and optical non-linearity and a shape or pattern having a grating period similar to light wavelength.

A photo crystal may control light propagation and spontaneous emission and may improve performance of optical devices. Accordingly, a photo crystal may contribute to miniaturization of an optical device.

The replica mold for nano imprinting 25 having the third pattern 23 in a grid form may be used to imprint a repetitive pattern. The repetitive pattern may have a dot structure that may serve as a photonic band gap structure so as to produce photo crystals.

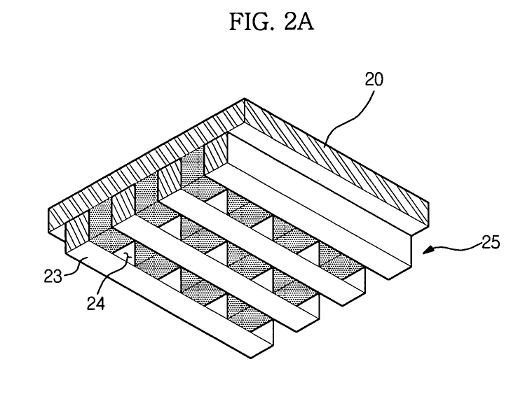

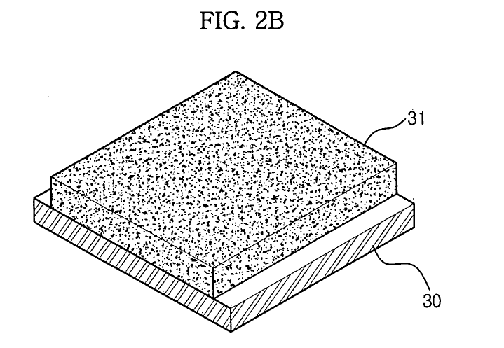

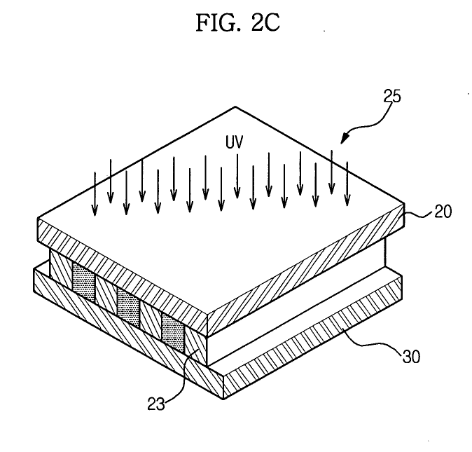

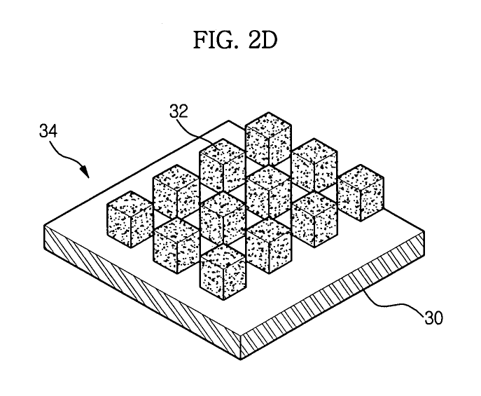

FIGS. 2A to 2D are process flow diagrams illustrating a method for producing photo crystals using the replica mold for nano imprinting 25 fabricated according to example embodiments.

Referring to FIG. 2A, the replica mold for nano imprinting 25 may be fabricated according to example embodiments, as shown in FIGS. 1A to 1E. Accordingly, the replica mold for nano imprinting 25 may have the third pattern 23 in a grid form as shown in FIG. 2A.

Referring to FIG. 2B, a first UV curable imprint resin 31 may be applied to a second substrate 30, on which a three-dimensional repetitive pattern in a dot structure is to be formed. The dot structure, for example, may be formed in columns. The second substrate 30 may be a substrate made of a material suitable for UV nano imprint processing. For example, the second substrate 30 may include flat panels based on glass, quartz or metal, as well as any flexible substrate, for example, PET or PEN.

Like the patterned mold resin 22 for fabricating the nano imprint mold 25, the imprint resin 31 may be prepared using UV curable polymer resin. In example embodiments, the patterned mold resin 22 on the nano imprint mold 25 may be identical to or different from the coated imprint resin 31 on the second substrate 30. In view of used materials, the mold resin 22 may be coated with an anti-adhesion layer in order to prevent adhesion between UV curable resins.

Referring to FIG. 2C, the nano imprint mold 25 with a grid type three-dimensional pattern 23 may be combined with the second substrate 30. More particularly, the nano imprint mold 25 may be pressed on the second substrate 30 coated with the imprint resin 31, and the imprint resin 31 may be patterned by the imprinting process.

In example embodiments, the imprint resin 31 may flow into holes 24 defined by the grid type third pattern 23 of the nano imprint mold 25.

Collimated light UV radiation may be carried out at the nano imprint mold side 25. In example embodiments, the UV light cannot penetrate the third pattern 23 but instead passes only through regions not patterned with the third pattern 23, so that the imprint resin 31 aligned in the region not patterned with the third pattern 23 is exclusively hardened by UV irradiation. In other words, only the portions of the imprint resin 31 that are in the holes 24 of the third pattern 23 are hardened by the UV radiation.

Referring to FIG. 2D, the nano imprint mold 25 may be released from the imprint resin 31. An unhardened portion of the imprint resin 31 may be washed with a solvent, for example, alcohol, to remove the same, thereby completing production of photo crystals 34 having the repetitive pattern 32 in a dot structure on the second substrate 30.

A shape of a dot may be altered by the form of the grid. In example embodiments, the grid may be formed such that linear lines spaced apart at equal intervals perpendicularly cross over one another. As a result, the dot structure may include column type patterns 32 with rectangular or square cross sections, which may be formed at equal intervals and have a uniform shape.

As illustrated in FIGS. 1A-1E and 2A-2D, example embodiments provide for a method of fabricating a dot structure having a rectangular or square cross section. However, example embodiments are not limited thereto as explained below.

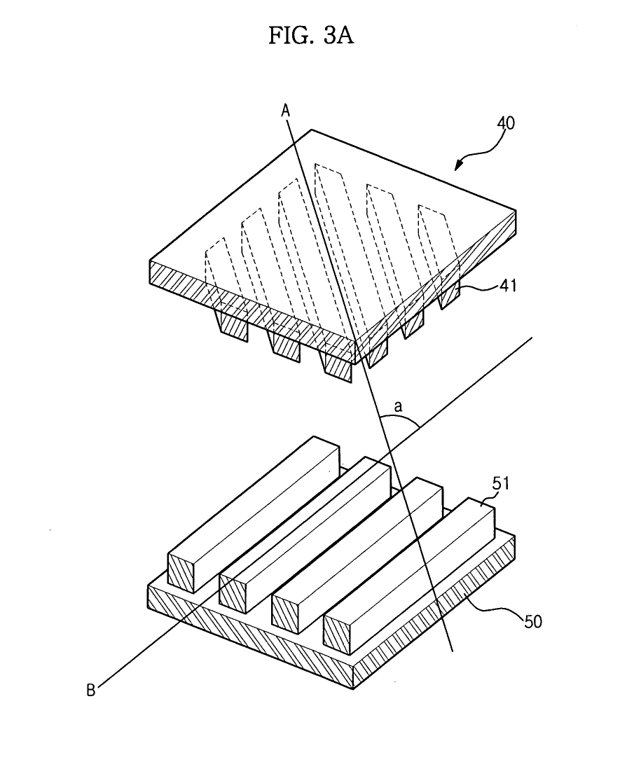

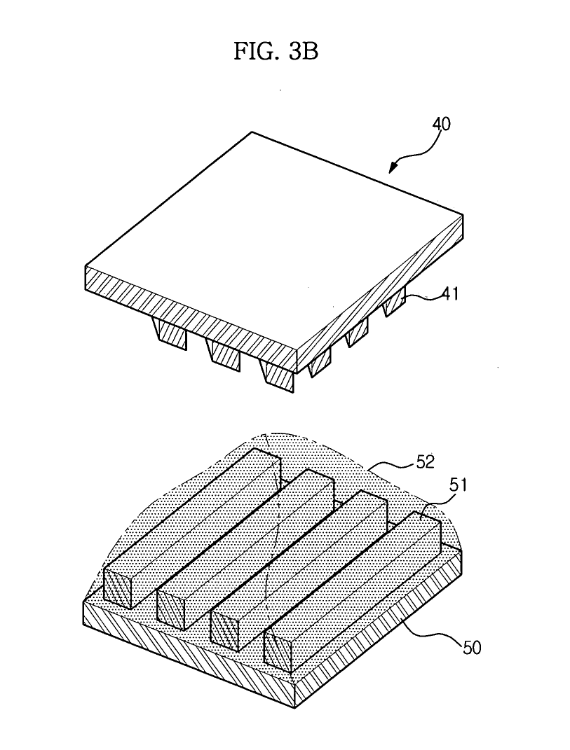

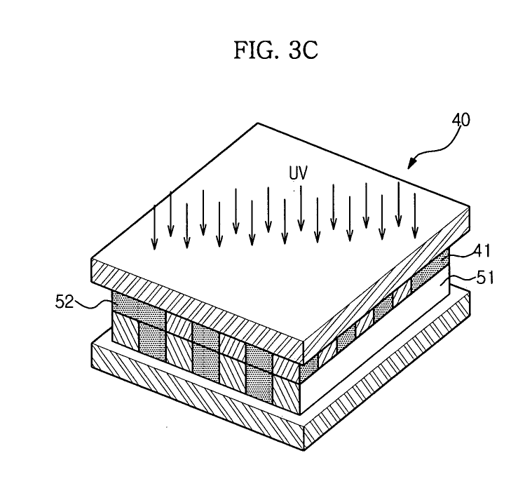

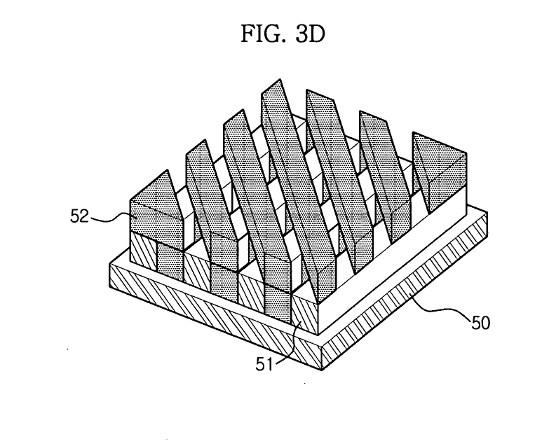

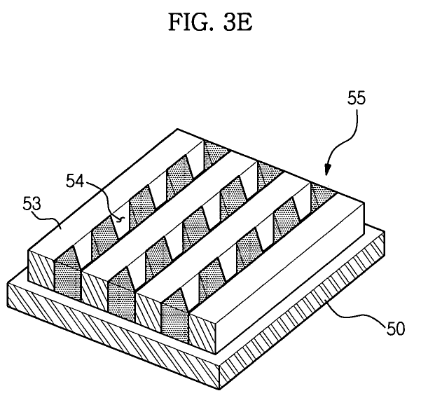

FIGS. 3A to 3E are process flow diagrams illustrating a method for fabricating a replica mold for nano imprinting by a dry etching process as well as nano imprinting, according to example embodiments.

Referring to FIG. 3A, a master mold 40 and a first substrate 50 may be prepared. The master mold 40 and the first substrate 50 may have first and second patterns 41 and 51 formed thereon, respectively, by conventional patterning processes, for example, photo lithography, nano imprint lithography, and E-beam lithography.

Although example embodiments illustrate linear patterns 41 and 51 aligned in parallel at equal intervals, which have a certain orientation, other patterns including, for example, linear patterns aligned in parallel at irregular intervals or streamline type patterns aligned in parallel, may also be formed.

The first pattern 41 of the master mold 40 may be different from the second pattern 51 of the first substrate 50. In example embodiments, the second pattern 51 may be a metal pattern.

The master mold 40 and the first substrate 50 patterned with first and second patterns 41 and 51 may be arranged so that the first pattern 41 of the master mold 40 and the second pattern 51 of the first substrate 50 cross over each other. In this regard, depending on a cross angle “a” between the first pattern 41 formed in direction A of the master mold 40 and the second pattern 51 formed in direction B of the first substrate 50, a shape of a third pattern 53 (see FIG. 3E) may be determined or established. As shown in FIG. 3A, the cross angle “a” between the first pattern 41 of the master mold 40 and the second pattern 51 of the first substrate 50 may be set to about 45°. Although example embodiments disclose that a cross angle “a” between the pattern of the master mold 40 and the pattern of the first substrate 50 may be set to about 45°, example embodiments are not limited thereto. For example, the cross angle “a” may be set at an angle other than about 45°.

As shown in FIGS. 3B to 3D, a UV curable mold resin 52 may be applied between the master mold 40 and the first substrate 50 by the same procedure as described previously. After application of the mold resin 52 is completed, the master mold 40 may be combined with the first substrate 50. The master mold 40 may be pressed which in turn may press the mold resin 52 applied between the master mold 40 and the first substrate 50. Following this, the mold resin 52 may be imprinted. The mold resin may be hardened by applying UV radiation at the master mold side 40 and the master mold 40 may be released from the mold resin 52 to obtain the first substrate 50 patterned with the mold resin 52, which includes the second pattern 51.

Referring to FIG. 3E, a specific gas capable of etching only the mold resin 52 may be used to execute a dry etching process, for example, RIE. In example embodiments, the dry etching process may be continued until a residual film is completely removed, resulting in a replica mold for nano imprinting 55 with a third pattern 53 having a three-dimensional pattern. As shown in FIG. 3E, the third pattern 53 may be formed in a grid form with diamond shaped holes 54 in the grid.

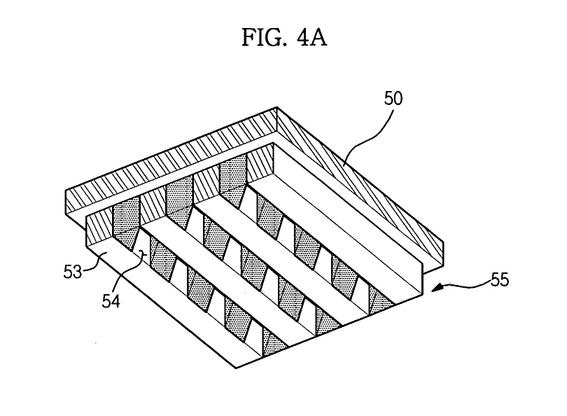

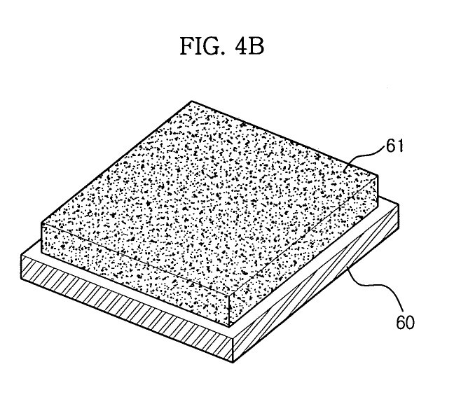

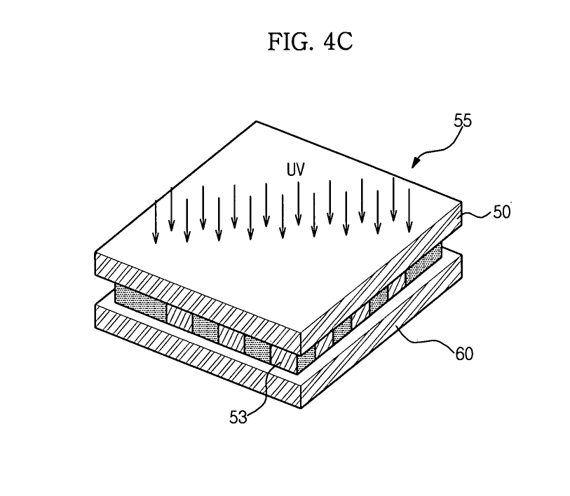

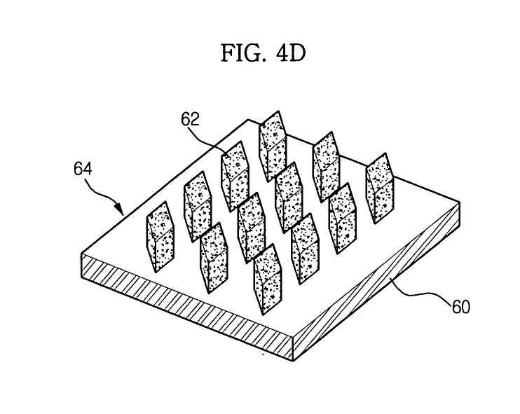

FIGS. 4A to 4D are process flow diagrams illustrating a method for producing photo crystals using the replica mold for nano imprinting 55 fabricated according to the example embodiments as illustrated in FIGS. 3A-3E.

Referring to FIG. 4A, the replica mold for nano imprinting 55 may be prepared according to the steps illustrated in FIGS. 3A-3E.

Referring to FIGS. 4B and 4C, a UV curable imprint resin 61 may be applied to a second substrate 60 by the same procedure as described previously in which a dot type pattern 32 is formed. The nano imprint mold 55 having a grid type three-dimensional pattern 53 may be combined with the second substrate 60. More particularly, the nano imprint mold 55 may be pressed on the second substrate 60 coated with the imprint resin 61, and the imprint resin 61 may be patterned by the imprinting process.

In example embodiments, the imprint resin 61 may flow into the diamond-shaped holes 54 defined by the grid type third pattern 53 of the nano imprint mold 55. Collimated light UV irradiation may be carried out at the nano imprint mold side 55. The UV light cannot penetrate a region patterned with the third pattern 53 but instead passes only through a region not patterned with the third pattern 53. Accordingly, the imprint resin 61 aligned in the region not patterned with the third pattern 53 may be exclusively hardened by the UV radiation. In other words, only the imprint resin 61 in the diamond shaped holes 54 are hardened by the UV radiation.

Referring to FIG. 4D, the nano imprint mold 55 may be released from the imprint resin 61 and an unhardened portion of the imprint resin 61 may be washed with a solvent, for example, alcohol, to remove the unhardened portions of the imprint resin and to obtain the repetitive pattern 62 of diamond shaped dot structures on the second substrate 60.

A pattern with a grid structure may be fabricating having different forms of holes, for example, a rectangular shape or a diamond shape, depending on a cross angle between a first pattern and a second pattern. Moreover, patterns with various grid structures may be used to form repetitive patterns of column dot structures having different shapes of cross sections.

Hereinafter, with use of the mold for nano imprinting 25 or 55 fabricated according to the above description, a method of forming of a repetitive pattern 32 or 62 having a dot structure by a nano imprint process will be described, in terms of operational procedures and functional effects thereof.

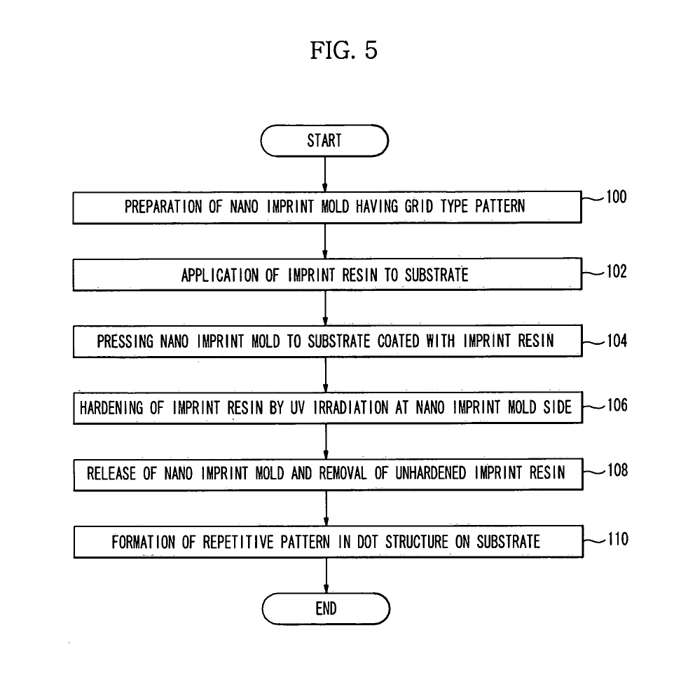

FIG. 5 is an operation block diagram illustrating a method for producing photo crystals, on which a repetitive pattern of dot structures may be formed by the nano imprint processes according to example embodiments.

Referring to FIG. 5, each of the nano imprint molds 25 and 55 may have grid type patterns fabricated according to example embodiments (operation 100; see FIGS. 1A to 1E, and FIGS. 3A to 3E). For example, the nano imprint mold 25 may have the grid type pattern 23 having square or rectangular holes 24 and the nano imprint mold 55 may have the grid type pattern 53 having the diamond shape holes 54.

A UV curable imprint resin 31 or 61 may be applied to a second substrate 30 or 60 (operation 102). The nano imprint mold 25 or 55 may be combined with the second substrate 30 or 60. More particularly, the nano imprint mold 25 or 55 may be pressed to the second substrate 30 or 60 coated with the imprint resin 31 or 61 (operation 104).

Collimated light UV irradiation may be irradiated on the nano imprint mold side 25 or 55 to harden the imprint resin 31 or 61 (operation 106).

The nano imprint mold 25 or 55 may be released from the imprint resin 31 or 61 and an unhardened portion of the imprint resin 31 or 61 may be washed with a solvent, for example, alcohol, to remove unhardened portions of the imprint resin 31 or 61 (operation 108). As a result, columns of rectangular 32 or diamond shape 62 dot structures are patterned on the second substrate 30 or 60 (operation 110; see FIGS. 2D and 4D).

The UV nano imprint process may be terminated when the repetitive pattern 32 or 62 in a dot structure is formed on the second substrate 30 or 60.

Although example embodiments are illustrated by a nano imprint process in UV curing mode, it is possible to adopt a nano imprint process in thermo-curing mode.

In accordance with example embodiments, a repetitive pattern having dot structures may be formed by a nano imprint mold having a grid type pattern. Because repetitive patterns with complex dot structures are obtainable by only a single process, example embodiments may omit an expensive exposure process typically used in the art.

In accordance with example embodiments, a simple and repetitive process as described above may be applicable to manufacture photo crystals, therefore, processing costs and processing times may be reduced and/or a production yield may be increased.

The photo crystals manufactured as described above may be used in a variety of applications including, for example, manufacture of various optical devices, for example, a micro-laser, high efficiency LED, photonic switch, and optical waveguide, as well as a process for manufacturing color filters of TFT-LCD with use of photo crystalline structures.

While example embodiments have been particularly shown and described with reference to example embodiments thereof, it will be understood by those of ordinary skill in the art that various changes in form and details may be made therein without departing from the spirit and scope of the following claims.

What is claimed is:

1. A method of fabricating a mold for nano imprinting comprising:
providing a master mold having a first pattern;
providing a substrate having a second pattern;
arranging the master mold on the substrate so that the first pattern and the second pattern cross over each other;
applying resin between the master mold and the substrate;
imprinting the resin by pressing the master mold against the substrate;
hardening the resin;
releasing the master mold from the resin; and
etching the hardened resin to form a replica mold for nano imprinting.

2. The method according to claim 1, wherein
arranging the master mold on the substrate includes arranging the first pattern perpendicular to the second pattern.

3. The method according to claim 1, wherein
a shape of a hole in the replica mold is varied depending on a cross angle between the first pattern and the second pattern.

4. The method according to claim 1, wherein
etching the hardened resin includes dry etching with a resin etchable gas until a residual film is removed.

5. The method according to claim 1, wherein
etching the hardened resin forms a pattern in a grid form.

6. The method according to claim 1, further comprising:
surface treating the replica mold using an anti-adhesive layer.

7. The method according to claim 1, wherein:
applying resin between the master mold and the substrate includes adding an adhesion promoter to enhance adhesiveness between the substrate and the resin.

8. A method of fabricating a mold for nano imprinting comprising:
preparing a master mold patterned with first linear patterns in parallel;
preparing a substrate patterned with linear metal patterns in parallel;
arranging the master mold and the substrate such that both the first linear patterns and the linear metal patterns cross over each other;
applying resin between the master mold and the substrate;
imprinting the substrate and the master mold and hardening the resin; and
etching the hardened resin after the master mold is released, so as to form a replica mold for nano imprinting patterned with a third pattern in a grid form.

9. A method of producing photo crystals comprising:
applying a mold resin between a master mold and a first substrate and imprinting the mold resin;
hardening the mold resin;
forming a replica mold by etching the hardened mold resin to form a grid type pattern on the first substrate;
coating an imprint resin on a second substrate;
pressing the replica mold against the coated second substrate to imprint the grid type pattern of the replica mold on the imprint resin; and
releasing the replica mold from the imprint resin.

10. The method according to claim 9, further comprising:
arranging the master mold and the first substrate so that a first pattern on the master mold and a second pattern on the first substrate cross over each other.

11. The method according to claim 9, wherein
forming the replica mold includes surface treating the replica mold by applying an anti-adhesion layer thereto.

12. The method according to claim 9, wherein the imprint resin includes a nano imprint material that is UV curable.

13. The method according to claim 9, wherein
the second substrate includes rectangular protrusions, the rectangular protrusions being spaced apart from one another and having a uniform size.
